(19) United States
(12) Patent Application Publication
(10) Pub. No.: US 2017/0182741 A1
(43) Pub. Date: Jun. 29, 2017

(54) SYSTEMS AND METHODS OF PRODUCING A STRUCTURAL AND NON-STRUCTURAL HOMOGENEOUS AND HYBRID COMPOSITE PANELS, PREPREGS, HAND LAYUP PANELS WITH "BASALT" FIBER, VARIOUS COMPOSITE MATERIALS, AND ADDITIVES

(71) Applicants: Veera AYITHI, Boca Raton, FL (US); Olenka WOODWARD, Boca Raton, FL (US); Vasu AYITHI, Boca Raton, FL (US); James WOODWARD, Boca Raton, FL (US)

(72) Inventors: Veera AYITHI, Boca Raton, FL (US); Olenka WOODWARD, Boca Raton, FL (US); Vasu AYITHI, Boca Raton, FL (US); James WOODWARD, Boca Raton, FL (US)

(21) Appl. No.: 15/300,199

(22) PCT Filed: Mar. 30, 2015
(86) PCT No.: PCT/US2015/023369

§ 371 Date: Sep. 28, 2016

Related U.S. Application Data
(63) Continuation of application No. 14/664,858, filed on Mar. 21, 2015, now abandoned.
(60) Provisional application No. 61/972,320, filed on Mar. 30, 2014.

(51) Int. Cl. B32B 9/00; B32B 5/26; B32B 3/12; B32B 5/02; B32B 9/04

(52) U.S. Cl. CPC B32B 9/002; B32B 5/024; B32B 9/04; B32B 3/12; B32B 5/26; B32B 2250/40; B32B 2260/023; B32B 2260/046; B32B 2262/10; B32B 2307/306; B32B 2307/3065; B32B 2307/52; B32B 2307/54; B32B 2307/558; B32B 2307/714; B32B 2607/00

(57) ABSTRACT

Systems and methods relating to a composite flat panel, curved panel, hand-layup panel, prepreg, skin, or composite core matrix panel are provided. In some aspects, it includes a core sandwiched between a first layer and a second layer. At least one of the first layer or the second layer includes a hardening material. At least one of the first layer or the second layer includes a basalt fiber. In other aspects, it includes a hand-layup panel, prepreg, or skin. The hand-layup panel, prepreg or skin includes a layer that includes a hardening material. The layer includes a basalt fiber. In other aspects, it includes a hand-layup panel, prepreg, or skin. It includes a first layer and a second layer, each of the first and second layer includes a hardening material. Each of the first and second layer includes a basalt fiber.

### CROSS-REFERENCE TO RELATED APPLICATIONS

This application claims priority to co-pending U.S. Provisional Patent Application Ser. No. 61/972,320, filed Mar. 30, 2014, and co-pending U.S. Utility patent application Ser. No. 14/664,858, filed Mar. 21, 2015, the entire disclosures of which are incorporated herein by reference.

### FIELD

The present inventive concept relates generally to basalt fiber composite panels. More specifically, the present inventive concept is concerned with the production of structural and non-structural composite flat panels, composite curved panels, composite prepregs, composite skins, hand-layup panels and various core matrix panels by using basalt as one of the substrate and utilization of basalt fiber in the form of fabrics, meshes, cells, hard panels, fiber, layers, and skins.

### SUMMARY

The present inventive concept comprises systems and methods relating to a composite flat panel, curved panel, hand-layup panel, prepreg, skin, or composite core matrix panel. One object is to provide a composite product with a core sandwiched between a first layer and a second layer. At least one of the first layer or the second layer includes a hardening material. At least one of the first layer or the second layer includes a basalt fiber.

Another object is to provide a hand-layup panel, prepreg, or skin. The hand-layup panel, prepreg or skin includes a layer that includes a hardening material. The layer includes a basalt fiber.

Another object is to provide a hand-layup panel, prepreg, or skin. It includes a first layer and a second layer, each of the first and second layer includes a hardening material. Each of the first and second layer includes a basalt fiber.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

Preferred embodiments of the inventive concept, illustrative of the best mode in which the applicants have contemplated applying the principles, are set forth in the following description, shown in the drawings, and particularly and distinctly pointed out and set forth in the appended claims.

FIG. 1 is an exemplary embodiment of a composite flat panel of the present inventive concept.

FIG. 2 is an exemplary embodiment of a composite curved panel of the present inventive concept.

FIG. 3 is an exemplary embodiment of a composite hand-layup panel of the present inventive concept.

FIG. 4 is an exemplary embodiment of a composite prepreg or skin of the present inventive concept.

FIG. 5 is an exemplary embodiment of a composite skin of the present inventive concept.

### DETAILED DESCRIPTION

As required, a detailed embodiment of the present inventive concept is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present inventive concept in virtually any appropriately detailed structure.

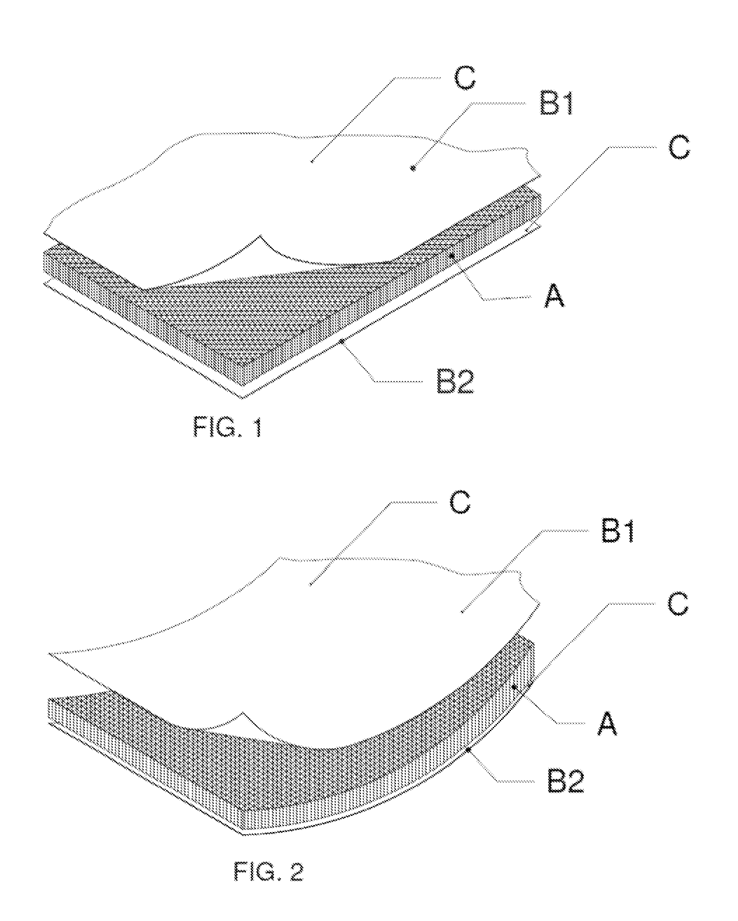

Referring to FIG. 1, an exemplary embodiment of a composite flat panel of the present inventive concept is provided. As shown in FIG. 1, the composite flat panel includes a core A sandwiched between a first layer B1 and a second layer B2. The first layer B1 and second layer B2 include a hardening material C.

Referring to FIG. 2, an exemplary embodiment of a composite curved panel of the present inventive concept is provided. As shown in FIG. 2, the composite curved panel includes a core A sandwiched between a first layer B1 and a second layer B2. The first layer B1 and second layer B2 include a hardening material C.

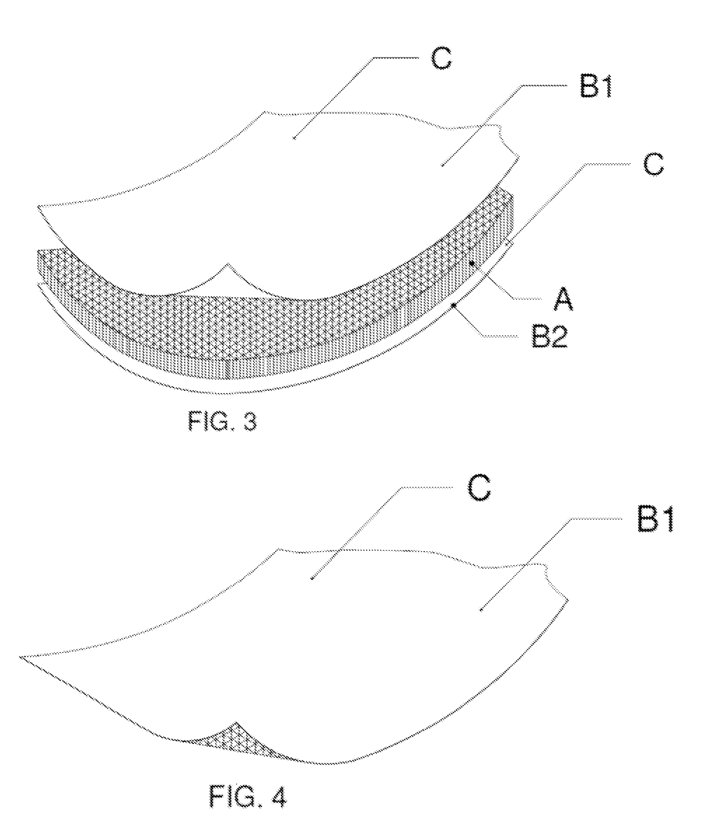

Referring to FIG. 3, an exemplary embodiment of a composite curved hand-layup panel of the present inventive concept is provided. As shown in FIG. 3, the composite curved hand-layup panel includes a core A sandwiched between a first layer B1 and a second layer B2. The first layer B1 and second layer B2 include a hardening material C.

Referring to FIG. 4, an exemplary embodiment of a composite prepreg or skin of the present inventive concept is provided. As shown in FIG. 4, the composite prepreg or skin includes a layer B1 and a hardening material C.

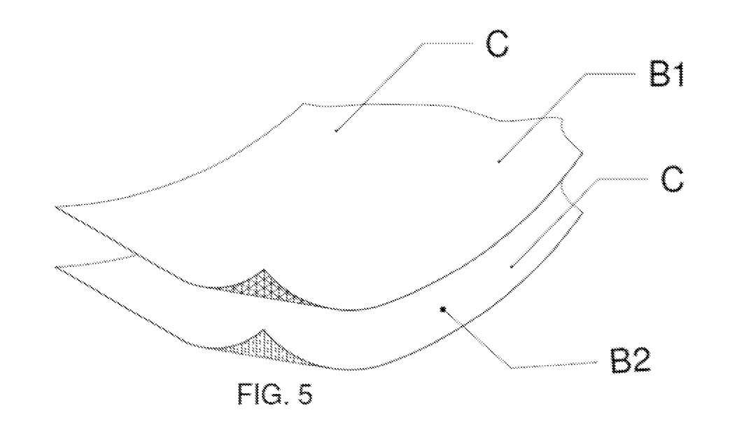

Referring to FIG. 5, an exemplary embodiment of a composite skin of the present inventive concept is provided. As shown in FIG. 5, the composite skin includes a first layer B1 and a second layer B1, and each layer includes a hardening material C.

In some embodiments, the present inventive concept relates to methods of production of structural and non-structural composite flat panels, composite curved panels, composite prepregs, composite skins, hand-layup panels and various core matrix panels by using Basalt as one of the substrate and utilization of “Basalt” fiber in the form of fabrics, meshes, cells, hard panels, fiber, layers, and skins. The Basalt fabric, mesh, layer, or skin is stiffened and hardened by using Epoxy resins, Phenolic resins, Bismalemides, Polyimides, curing agents, hardeners, reactive and or non-reactive additives, accelerators, tougheners, and flame retardants. The composite matrix (Table.2, Material A) is developed by utilizing different filler materials such as Basalt core, Honeycomb core, Nomex core, foam core, Balsa core, corrugated core, Hexagonal core, Reinforced hexagonal core, OX core, Flex core, Double flex core, tube core, Hybrid core, and other thermosetting cores.

These composite structural and non-structural panels, layers, skins and Prepregs are manufactured in various thicknesses, multiple plies of Basalt composition. The Basalt fabric or layer (Table.3, Material B1 & B2) can be used in unidirectional fabric, bi-axial fabric, quad-axial fabric, Multi-axial, Quasi-isotropic, twill weave, plain weave, and satin weave formats for making the skins, prepregs, plies, and layers. These Basalt fabrics and meshes are produced with various filament sizes.

Systems and methods of the present inventive concept include the producing of pre-impregnated epoxy filled basalt fabric, basalt composite panels, and the first-ever use of a combination of materials for the skin and core elements that will be used in transportation industries which include; aerospace, automotive, rail, and overseas shipping. The intended benefits of these combinations of materials are: increased strength, reduced weight, reduced electrostatic properties, higher heat resistance, corrosion resistance properties, higher stiffness, higher impact resistance, chemical resistance, and dark color for aesthetic appearance and increased environmentally friendly green properties.

The surface component of the composite panel is made from fibrous materials such as basalt, carbon fiber, and fiberglass. Hybrid fibrous materials that contain combinations of the fiber material within the skin material will also be used.

The pre-impregnated skins and core materials are joined by external molds under pressure and heat to attain critical shapes and final dimensions. In some embodiments, process and adhesive combinations create basalt prepreg materials shown in Table 1 using any one or more of the composite layers of Table 3 and any one or more of the composite materials of Table 4.

In some embodiments, process and fibrous material combinations create homogeneous and hybrid basalt fabrics by using basalt and interwoven various fibers that include: carbon fiber, Kevlar, aramid, and fiberglass. These processes and fibrous material combinations use any one or more of the composite layers of Table 3 and any one or more of the composite materials of Table 4.

In some embodiments, process and material combinations create “core” matrices that include organized multi-directional load-bearing structures sandwiched between aforementioned skins that transmit and distribute applied loads throughout the panel. The internal core structural configurations include unidirectional and multi-directional cross-sections, bi-axial fabric, quad-axial fabric, Multi-axial, Quasi-isotropic, twill weave, plain weave, and satin weave formats of material fibers and patterns such and square lattice, diamond lattice, layers of lattice network, and natural patterns such as hexagonal honeycomb core material epoxy matrix and foam will be used to align internal core materials and may utilize fiber reinforcement for additional strength and gas-filled for reduced weight. The structural and non-structural, homogeneous, non-homogenous, and hybrid composite products described in Table.1, and shown in FIGS. 1-5, are produced by using any one or more of the composite core matrices described in Table 2 (where a core is used), any one or more of the composite layers described in Table.3, and any one or more of the hardening materials described in Table 4.

In some embodiments, production of composite structural and non-structural flat panels, curved panels, hand lay-up panels, and various core matrix panels are created as described in Table 1, using any one or more of the core matrices described in Table.2 (where applicable), any one or more of the layers described in Table 3, and any one or more of the hardening materials described in Table 4.

TABLE 1
Structural/Non Structural, Homogeneous/Non-Homogenous/Hybrid

| Product description | Core | Skin Type 1 | Skin type 2 |
|---|---|---|---|
| Composite Flat Panels | A | B1 | B2 |
| Composite Curved Panels | A | B1 | B2 |
| Composite prepregs | — | B1 | B2 |
| Composite prepregs | — | B1 | B1 |
| Composite prepregs | — | B1 | — |
| Composite prepregs | — | B2 | — |
| Composite prepregs | — | B2 | B2 |
| Composite Skins | — | B1 | B1 |
| Composite Skins | — | B1 | — |
| Composite Skins | — | B2 | — |
| Composite Skins | — | B2 | B2 |
| Composite Hand lay-up panels | A | B1 | B2 |
| Composite Hand lay-up panels | A | B1 | B2 |
| Composite Hand lay-up panels | A | B1 | B1 |
| Composite Hand lay-up panels | A | B2 | B2 |

TABLE 2
Composite Core matrix-Structural/Non-structural-A.
Core type-A
Basalt Core
Honeycomb core
Nomex core
Foam core
Balsa core
Corrugated core
Hexagonal core
Reinforced hexagonal core
OX core
Flex core
Double flex core
Tube core
Hybrid core

TABLE 3
Composite Skins/Plies/Layers/Prepregs/Fabric/Mesh/cells-B1 & B2.
Unidirectional Fabric
B-axial fabric
Quad-axial fabric
Multi-axial fabric
Quasi-Isotropic
Twill weave
Plain weave
Satin weave
Square Lattice
Diamond Lattice

TABLE 4
Composite bonding/hardener/stiffener-C.
Epoxy resins
Phenolic resins
Bismalemides
Polyimides
Curing agents
Hardeners
Reactive & Non-Reactive Additives
Accelerators
Tougheners
Flame retardants

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A composite flat panel, curved panel, hand-layup panel, prepreg, skin, or composite core matrix panel comprising:
a core sandwiched between a first layer and a second layer;
wherein at least one of the first layer or the second layer includes a hardening material;
wherein at least one of the first layer or the second layer includes a basalt fiber
wherein the core is comprised of any one or more of Basalt core, Honeycomb core, Nomex core, foam core, Balsa core, corrugated core, Hexagonal core, Reinforced hexagonal core, OX core, Flex core, Double flex core, tube core, or Hybrid core;
wherein each of the first layer and second layer is comprised of any one or more of unidirectional fabric, bi-axial fabric, quad-axial fabric, Multi-axial, Quasi-isotropic, twill weave, plain weave, satin weave, square lattice, or diamond lattice; and
wherein the hardening material comprises any one or more of Epoxy resins, Phenolic resins, Bismalemides, Polyimides, curing agents, hardeners, reactive additives, non-reactive additives, accelerators, tougheners, or flame retardants.

2. A hand-layup panel, prepreg, or skin comprising:
a layer that includes a hardening material;
wherein the layer includes a basalt fiber,
wherein the layer is comprised of any one or more of unidirectional fabric, bi-axial fabric, quad-axial fabric, Multi-axial, Quasi-isotropic, twill weave, plain weave, satin weave, square lattice, or diamond lattice; and
wherein the hardening material comprises any one or more of Epoxy resins, Phenolic resins, Bismalemides, Polyimides, curing agents, hardeners, reactive additives, non-reactive additives, accelerators, tougheners, or flame retardants.

3. A hand-layup panel, prepreg, or skin comprising:
a first layer and a second layer, each of the first and second layer includes a hardening material;
wherein each of the first and second layer includes a basalt fiber;
wherein each of the first and second layer is comprised of any one or more of unidirectional fabric, bi-axial fabric, quad-axial fabric, Multi-axial, Quasi-isotropic, twill weave, plain weave, satin weave, square lattice, or diamond lattice; and
wherein the hardening material comprises any one or more of Epoxy resins, Phenolic resins, Bismalemides, Polyimides, curing agents, hardeners, reactive additives, non-reactive additives, accelerators, tougheners, or flame retardants.

4. A method of producing a composite flat panel, curved panel, hand-layup panel, prepreg, skin, or composite core matrix panel, the method comprising:
providing a core sandwiched between a first layer and a second layer;
wherein at least one of the first layer or the second layer includes a hardening material;
wherein at least one of the first layer or the second layer includes a basalt fiber
wherein the core is comprised of any one or more of Basalt core, Honeycomb core, Nomex core, foam core, Balsa core, corrugated core, Hexagonal core, Reinforced hexagonal core, OX core, Flex core, Double flex core, tube core, or Hybrid core;
wherein each of the first layer and second layer is comprised of any one or more of unidirectional fabric, bi-axial fabric, quad-axial fabric, Multi-axial, Quasi-isotropic, twill weave, plain weave, satin weave, square lattice, or diamond lattice; and
wherein the hardening material comprises any one or more of Epoxy resins, Phenolic resins, Bismalemides, Polyimides, curing agents, hardeners, reactive additives, non-reactive additives, accelerators, tougheners, or flame retardants.

5. A method of producing a hand-layup panel, prepreg, or skin, the method comprising:
providing a layer that includes a hardening material;
wherein the layer includes a basalt fiber;
wherein the layer is comprised of any one or more of unidirectional fabric, bi-axial fabric, quad-axial fabric, Multi-axial, Quasi-isotropic, twill weave, plain weave, satin weave, square lattice, or diamond lattice; and
wherein the hardening material comprises any one or more of Epoxy resins, Phenolic resins, Bismalemides, Polyimides, curing agents, hardeners, reactive additives, non-reactive additives, accelerators, tougheners, or flame retardants.

6. A method of producing a hand-layup panel, prepreg, or skin comprising:
providing a first layer and a second layer, each of the first and second layer includes a hardening material,
wherein each of the first and second layer includes a basalt fiber;
wherein each of the first and second layer is comprised of any one or more of unidirectional fabric, hi-axial fabric, quad-axial fabric, Multi-axial, Quasi-isotropic, twill weave, plain weave, satin weave, square lattice, or diamond lattice; and
wherein the hardening material comprises any one or more of Epoxy resins, Phenolic resins, Bismalemides, Polyimides, curing agents, hardeners, reactive additives, non-reactive additives, accelerators, tougheners, or flame retardants.
